(19) United States
(12) Patent Application Publication
(10) Pub. No.: US 2025/0211074 A1
(43) Pub. Date: Jun. 26, 2025

(54) SYSTEM AND METHOD FOR ROTOR SLEEVE INSTALLATION

(71) Applicant: GM GLOBAL TECHNOLOGY OPERATIONS LLC, Detroit, MI (US)

(72) Inventors: Derek F. Lahr, Ann Arbor, MI (US); Alireza Fatemi, Canton, MI (US); Ronald Buchholz, Casco, MI (US); Anthony M. Coppola, Rochester Hills, MI (US); Erik B. Golm, Sterling Heights, MI (US)

(73) Assignee: GM GLOBAL TECHNOLOGY OPERATIONS LLC, Detroit, MI (US)

(21) Appl. No.: 18/396,085

(22) Filed: Dec. 26, 2023

(51) Int. Cl. H02K 15/02; H02K 15/14

(52) U.S. Cl. CPC H02K 15/02; H02K 15/14; H02K 2215/00

(57) ABSTRACT

An assembly includes a rotor assembly having a rotor stack with an outer rotor diameter and a rotor shaft extending along a rotational axis of the rotor assembly. A mandrel includes an outer mandrel diameter extending between a proximal end and a distal end with a rotor engaging surface at the distal end of mandrel. The outer mandrel diameter includes a first cylindrical portion adjacent the proximal end, a conical portion distal of the first cylindrical portion with a first transitional portion connecting the first cylindrical portion to the conical portion. The assembly also includes a sleeve having an inner sleeve diameter that is less than the outer rotor diameter when in an unexpanded state.

### INTRODUCTION

The present disclosure relates to electric machines, and more particularly to electric machines including rotor assemblies with press-fit sleeves.

Electric vehicles (EVs) such as battery electric vehicles (BEVs), hybrid vehicles, and/or fuel cell vehicles include one or more electric machines and a battery system. The battery system provides power to the one or more electric machines and receives power from the one or more electric machines and/or a utility. The battery system includes one or more battery cells, modules and/or packs. A power control system is used to control charging and/or discharging of the battery system during charging and/or driving.

The electric machines include a rotor and stator. During manufacturing of the electric machines, a reinforcing sleeve may be installed onto an outer surface of the rotor to prevent expansion of the rotor assembly during operation.

### SUMMARY

Disclosed herein is an assembly. The assembly includes a rotor assembly having a rotor stack with an outer rotor diameter and a rotor shaft extending along a rotational axis of the rotor assembly. A mandrel includes an outer mandrel diameter extending between a proximal end and a distal end with a rotor engaging surface at the distal end of mandrel. The outer mandrel diameter includes a first cylindrical portion adjacent the proximal end, a conical portion distal of the first cylindrical portion with a first transitional portion connecting the first cylindrical portion to the conical portion. The assembly also includes a sleeve having an inner sleeve diameter that is less than the outer rotor diameter when in an unexpanded state.

Another aspect of the disclosure may be where an inner diameter of the mandrel engages an outer diameter of a bearing datum on the rotor assembly with a fastener engaging the bearing datum for securing the mandrel to the rotor assembly.

Another aspect of the disclosure may be where the mandrel includes a second cylindrical portion distal of the conical portion with the second cylindrical portion connected to the conical portion by a second transitional portion.

Another aspect of the disclosure may be where at least one of the first transitional portion or the second transitional portion on the mandrel includes a radius of curvature.

Another aspect of the disclosure may be where the radius of curvature is greater than a thickness of the sleeve divided by two times a maximum material strain of a material of the sleeve.

Another aspect of the disclosure may include a polymeric ring having a driver contact surface on a first axial face and a sleeve contact surface on a second axial face configured to engage a proximal end of the sleeve.

Another aspect of the disclosure may include a press having a sleeve driver with a body portion defining a central opening for surrounding the mandrel and a distal end having a ring engagement surface for engaging the driver contact surface on the polymeric ring and a pressure relieve hole extending through and defined by the body portion.

Another aspect of the disclosure may include a fixture base having a cylindrical body defining a central opening for accepting a portion of the rotor shaft of the rotor assembly.

Another aspect of the disclosure may include a flange located on an outer perimeter of the distal end of the mandrel, wherein a radially inner side of the flange defines a portion of a circumferential channel recessed into the distal end of the mandrel.

Another aspect of the disclosure may be where the outer rotor diameter and the outer mandrel diameter are each covered in a continuous coating of material and the continuous coating of material includes a radially outer surface located radially outward from the outer rotor diameter and the outer mandrel diameter relative to the rotational axis.

Another aspect of the disclosure may be where the distal end of the mandrel includes at least one projection configured to be accepting within a corresponding alignment opening defined by a portion of the rotor assembly.

Disclosed here is a method of installing a sleeve on a rotor assembly. The method includes aligning an outer mandrel diameter of a mandrel relative to an outer rotor diameter of a rotor assembly. The outer mandrel diameter includes a first cylindrical portion adjacent to a proximal end, a conical portion distal of the first cylindrical portion, and a first transitional portion connecting the first cylindrical portion to the conical portion. The method also includes pressing the sleeve over the outer mandrel diameter and onto the rotor assembly with a driver on a press with the sleeve configured to apply a compressive force to a portion of the rotor assembly surrounded by the sleeve.

Another aspect of the disclosure may include positioning a polymeric ring between a proximal end of the sleeve and a distal end of the driver.

Another aspect of the disclosure may be where pressing the sleeve over the outer mandrel diameter includes expanding a radial dimension of the sleeve to align with a radial dimension of an outer surface of the rotor assembly.

Another aspect of the disclosure may include attaching the mandrel to a bearing datum on a shaft of the rotor assembly to align an outer rotor diameter on a rotor stack with the outer mandrel diameter. An inner diameter of the mandrel engages an outer diameter of a bearing datum on the rotor assembly.

Another aspect of the disclosure may be where the mandrel includes a second cylindrical portion distal of the conical portion and connected to the conical portion by a second transitional portion.

Another aspect of the disclosure may be where a distal end of the mandrel includes a flexible flange surrounding an outer perimeter of the distal end that deflects to align with a radially outer surface of the rotor assembly.

Another aspect of the disclosure may include over molding the mandrel and the rotor assembly with a polymer coating of material and machining the polymer layer across the mandrel and the rotor assembly to create a consistent transition for the sleeve in a radial direction between the mandrel and the rotor assembly.

Another aspect of the disclosure may include applying a lubricant to the outer mandrel diameter and the outer rotor diameter and pressing the sleeve over the mandrel and rotor assembly with a velocity that is equal to or greater than a hydrodynamic lubrication velocity of the lubricant applied.

Disclosed herein is a press assembly for assembling a sleeve on to a rotor assembly. The press assembly includes a press having a driver and a fixture for supporting the rotor assembly. The rotor assembly includes a rotor stack having an outer rotor diameter and a rotor shaft extending along a rotational axis of the rotor assembly. The press assembly also includes a mandrel having an outer mandrel diameter extending between a proximal end and a distal end with a rotor engaging surface at the distal end of mandrel. The outer mandrel diameter includes a first cylindrical portion adjacent to the proximal end, a conical portion distal of the first cylindrical portion, and a first transitional portion connecting the first cylindrical portion to the conical portion. The sleeve includes an inner sleeve diameter that is less than the outer rotor diameter when in an unexpanded state.

### BRIEF DESCRIPTION OF THE DRAWINGS

FIG. 1 illustrates an example press assembly for assembling an example rotor assembly.

FIG. 2 illustrates an enlarged view of a mandrel aligned with the rotor assembly of FIG. 1.

FIG. 3 illustrates an enlarged view of an intersection of the mandrel of FIG. 2 with the rotor assembly of FIG. 1.

FIG. 4 illustrates an enlarged view of an intersection of another example mandrel and the rotor assembly of FIG. 1.

FIG. 5 illustrates yet another example mandrel aligned with another example rotor assembly.

FIG. 6 illustrates a method of assembling a sleeve onto the rotor assembly of FIG. 1 or the rotor assembly of FIG. 5.

The present disclosure may be modified or embodied in alternative forms, with representative embodiments shown in the drawings and described in detail below. The present disclosure is not limited to the disclosed embodiments. Rather, the present disclosure is intended to cover alternatives falling within the scope of the disclosure as defined by the appended claims.

### DETAILED DESCRIPTION

Those having ordinary skill in the art will recognize that terms such as “above,” “below”, “upward”, “downward”, “top”, “bottom”, “left”, “right”, etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may include a number of hardware, software, and/or firmware components configured to perform the specified functions.

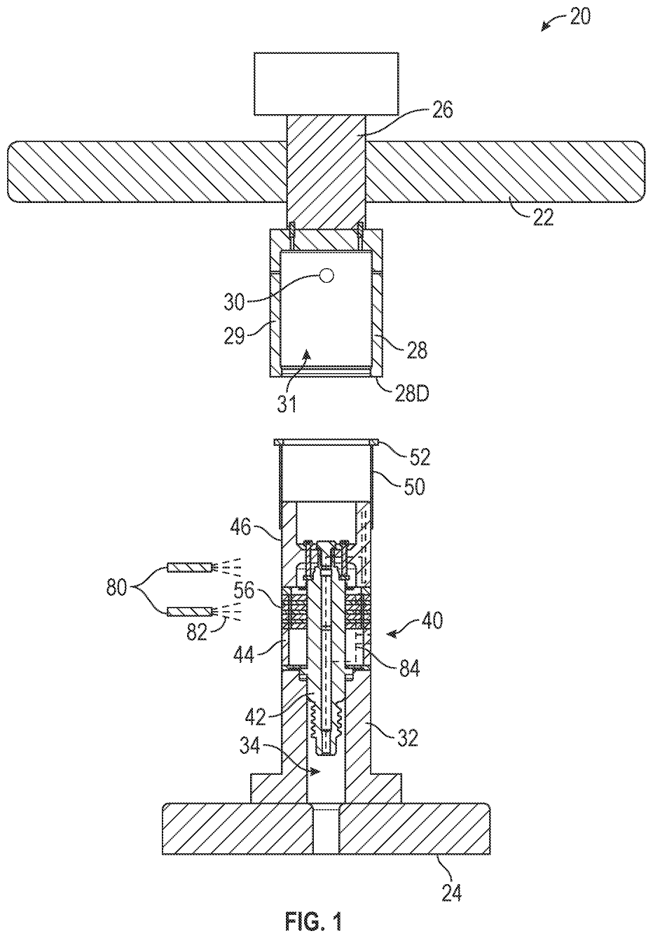

Referring to the FIGS., wherein like numerals indicate like parts referring to the drawings, wherein like reference numbers refer to like components, FIG. 1 shows a schematic view of a press assembly 20 used for assembly of a sleeve 50 onto a rotor assembly 40 through use of a mandrel 46. In the illustrated example, the press assembly 20 includes an upper frame support 22 and a lower frame support 24. The upper frame support 22 at least partially supports a press arm 26, such as a servo press, with a sleeve driver 28 attached to a distal end of the press arm 26 for moving the sleeve 50 relative to the rotor assembly 40.

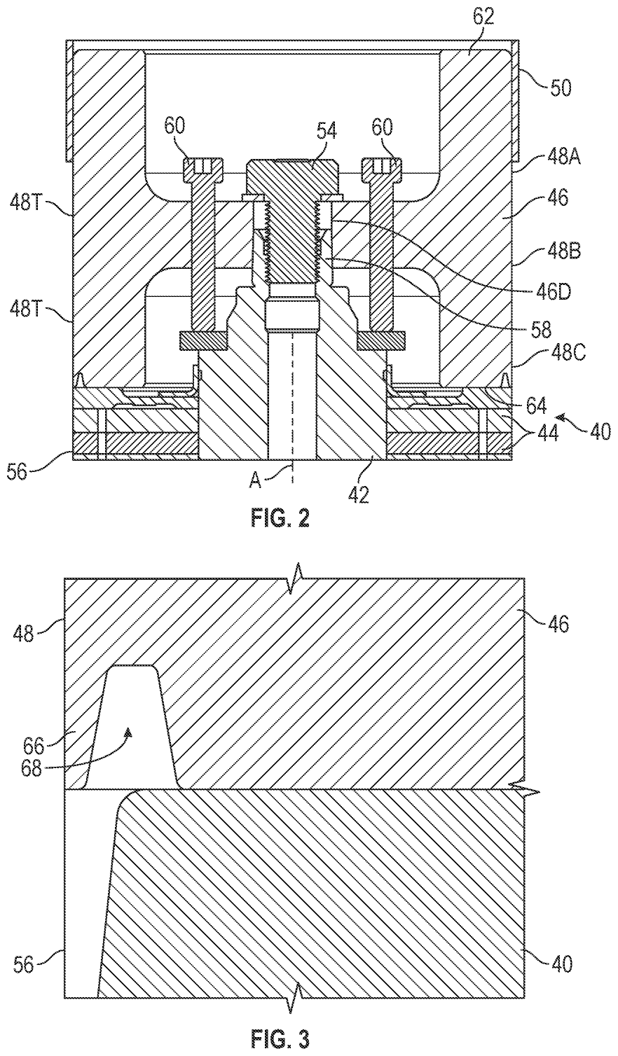

In the illustrated example, the rotor assembly 40 includes a stack of laminations forming a rotor stack 44 having an outer rotor diameter 56 with a rotor shaft 42 extending along a rotational axis A (FIG. 2) of the rotor assembly 40. During assembly, the rotor assembly 40 is supported on a fixture base 32 that sits on top of the lower frame support 24. The fixture base 32 includes a cylindrical body having a central opening 34 for accepting a portion of the rotor assembly 40. In the illustrated example, the fixture base 32 accepts a portion of a rotor shaft 42 within the central opening 34. A distal end of the fixture base 32 opposite the lower frame support 24 includes a ledge that engages an edge of the rotor stack 44 to prevent the rotor assembly 40 from moving longitudinally relative to the axis of rotation A.

As shown in FIGS. 1 and 2, the mandrel 46 is press fit onto the rotor assembly 40 and can be secured with or without a fastener 54, such as a bolt. In the illustrated example, the fastener 54 is in threaded engagement with a bearing datum 58 on an end of the rotor shaft 42 and an inner diameter 46D of the mandrel 46 is in engagement with an outer diameter of the bearing datum 58. One feature of this attachment arrangement is improved alignment between an outer rotor diameter 56 on the rotor stack 44 with an outer mandrel diameter 48 on the mandrel 46.

Furthermore, multiple jack screws 60 are located radially outward from the fastener 54 and are in threaded engagement with the mandrel 46 along a shaft of the jack screws 60. The jack screws 60 aid in removing the mandrel after the sleeve 50 has been installed by extending them to engage a portion of the rotor assembly 40.

The outer mandrel diameter 48 on the mandrel 46 extends between a proximal end 62 of the mandrel 46 and a distal end 64 of the mandrel 46. The distal end 64 includes a rotor engaging surface that directly abuts a portion of the rotor assembly 40. As shown in FIG. 2, the outer mandrel diameter 48 includes a first cylindrical portion 48A adjacent the proximal end 62, a conical portion 48B distal of the first cylindrical portion 48A, and a second cylindrical portion 48C adjacent the distal end 64. A first transitional portion 48T connects the first cylindrical portion 48A to the conical portion 48B and a second transitional portion 48T connects the conical portion 48B to the second cylindrical portion 48C. An inner diameter of the sleeve 50 can have an inner sleeve diameter that is greater than or equal to a diameter of the first cylindrical portion 48A and less than a diameter of the conical portion 48B or the second cylindrical portion 48C. This allows the sleeve 50 to be easily placed over the proximal end 62 of the mandrel 46 during installation.

At least one of the first transitional portion 48T or the second transitional portion 48T in the mandrel 46 includes a radius of curvature that joins the first and second cylindrical portions 48A and 48C to the conical portion 48B. One feature of the transitional portions 48T is to prevent damage to the sleeve 50 during installation as the sleeve 50 moves across sections of the mandrel 46 having different conical shapes. In one example, the radius of curvature of the transitional portions 48T is greater than or equal to a thickness of the sleeve 50 divided by two times a maximum material strain of a material of the sleeve 50.

As shown in FIG. 1, a ring 52, such as a polymeric ring comprised of nylon or torlon, is placed on a proximal end of the sleeve 50. The ring 52 includes a first axial face defining a driver contact surface for engaging a distal end of the sleeve driver 28 and a second axial face defining a sleeve contact surface for engaging a proximal end of the sleeve 50. One feature of the ring 52 is to reduce lateral loads to the sleeve 50 and to evenly apply pressure to the sleeve 50 to reduce damage to the sleeve 50. Another feature of the ring 52 is that it expands with the sleeve 50 to allow axial force to be applied to the sleeve 50 while the sleeve 50 expands. In particular, the sleeve 50 is constructed with significantly more strength in the circumferential direction than a longitudinal direction in order to apply compressive stress to the rotor stack 44 with a low amount of weight. In one example, the sleeve 50 is comprised of a carbon fiber material. Also, the distal end of the mandrel 46 and the proximal end of the rotor assembly 40 can have a fillet or radius of curvature along their outer diameters to facilitate a transition when the sleeve 50 passes between them to prevent damage to the sleeve 50.

As shown in FIG. 1, the press arm 26 includes the sleeve driver 28 at a distal end having a body portion 29 for engaging the ring 52 and pressing the sleeve 50 onto the rotor assembly 40. The distal end 28D of the sleeve driver 28 defines a ring engagement surface surrounding an interior chamber 31 for accepting the mandrel 46 when pressing the sleeve 50 over the mandrel 46 and onto the rotor assembly 40. A pressure relief hole 30 extends through and is defined by a portion of the body portion 29 to release pressure that forms in the interior chamber 31.

As shown in FIGS. 2 and 3, a flange 66, such as a flexible flange, is located on an outer perimeter of the distal end 64 of the mandrel 46. A radially inner side of the flange 66 defines a portion of a circumferential channel 68 recessed into the distal end 64 of the mandrel 46. One feature of the flange 66 is that it can deflect radially inward relative to a longitudinal axis of the mandrel 46 to provide improved alignment between the mandrel 46 and the rotor assembly 40.

Due to manufacturing limitations, it can be difficult to machine and install the mandrel 46 with tolerances between the outer mandrel diameter 48 and the outer rotor diameter 56 that will not damage the sleeve 50 during installation. The sleeve 50 can be prone to failing during installation due to the circumferential strength of the sleeve 50 being much greater than a longitudinal strength of the sleeve 50. The compressive force from the sleeve 50 can cause the flange 66 to deflect or flex radially inward and align with outer rotor diameter 56 during installation. Furthermore, this can allow the outer mandrel diameter 48 at the distal end 64 to be manufactured within a tolerance that is larger than the outer rotor diameter 56 to allow the flange 66 to accommodate for the variation in diameters.

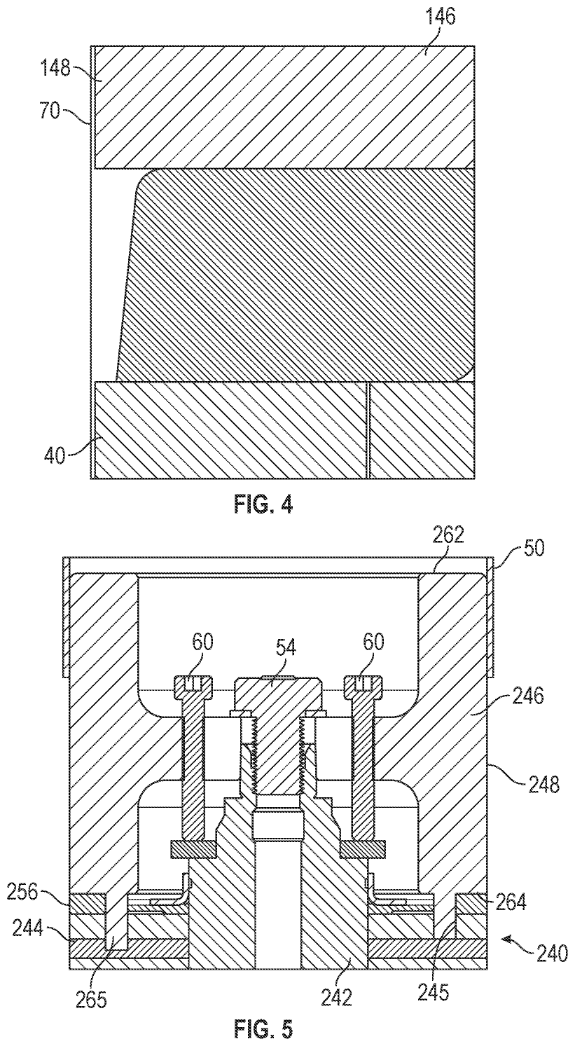

FIG. 4 illustrates another example mandrel 146 adjacent to the rotor assembly 40. The mandrel 146 is similar to the mandrel 46 except that the mandrel 146 does not include the flange 66 with the adjacent channel 68. Similar or like components between the mandrel 46 and the mandrel 146 will include the addition of a leading “1”.

In the illustrated example, an outer mandrel diameter 148 of the mandrel 146 and the outer rotor diameter 56 of the rotor assembly 40 are both covered in a continuous coating or layer of material 70. In one example, the coating of material includes a polymer material. The continuous coating of material 70 includes a radially outer surface located radially outward from the outer rotor diameter 56 and the outer mandrel diameter 48 relative to the rotational axis A. The coating of material 70 provides a continuous surface for the sleeve 50 to slide across. In one example, the coating of material 70 can be machined after it is applied to both the mandrel 146 and the rotor assembly 40. The mandrel 146 can be separated from the rotor assembly by fracturing the coating of material 70 after the sleeve 50 has been installed. The coating of material 70 can be removed from the mandrel 146 such that the mandrel 146 can be placed onto another rotor assembly 40.

FIG. 5 illustrates another example mandrel 246 and another example rotor assembly 240. The mandrel 246 and rotor assembly 240 are similar to the mandrel 46 and rotor assembly 40, respectively, except where described below or shown in the drawings. Similar or like components between the mandrel 46 and rotor assembly 40 and the mandrel 246 and rotor assembly 240, respectively, will include the addition of a leading “2”.

The mandrel 246 includes a proximal end 262 and a distal end 264 that is in abutting contact with a rotor stack 244 in the rotor assembly 240. The rotor assembly 240 includes a rotor shaft 242. The distal end 264 of the mandrel 246 includes at least one projection 265, such as a pin having a round or oval cross section, that mates with an alignment opening 245 or recess in the rotor stack 244 in the rotor assembly 240. The interface between the at least one projection 265 and the alignment opening 245 provide improved alignment between the outer mandrel diameter 248 on the mandrel 246 and the radially outer surface 256 on the rotor stack 244 of the rotor assembly 240.

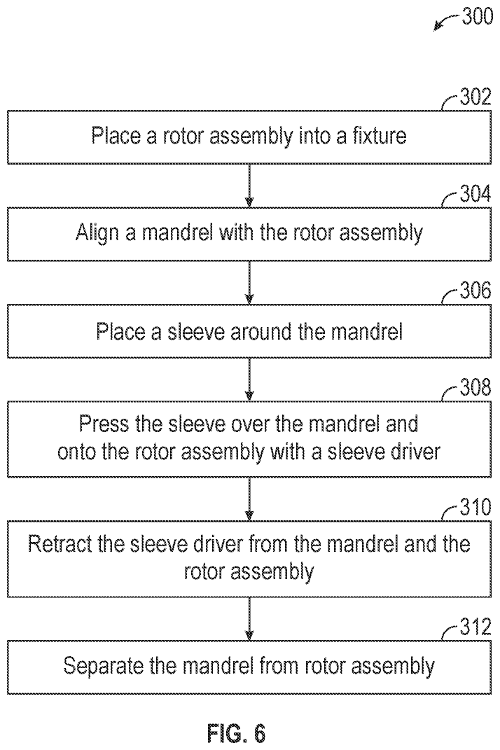

FIG. 6 illustrates an example method 300 of assembling the sleeve 50 onto the rotor assembles 40. The method 300 will also apply to assembling the sleeve 50 onto the rotor assembly 240 with differences identified below. The method 300 begins at Block 302 with placing one of the rotor assembly 40 into the fixture base 32. This allows the rotor assembly 40 to float laterally in the fixture base 32 to allow for improved alignment while pressing the sleeve 50 as explained further below.

At Block 304, the mandrel 46 is aligned with the rotor assembly 40. The mandrel 46 is aligned with the rotor assembly 40 by aligning the outer mandrel diameter relative to the outer rotor diameter. The alignment can occur by aligning a central longitudinal axis of the mandrel 46 with the axis of rotation A of the rotor assembly 40. This ensures variations between the outer mandrel diameter and the outer rotor diameter are minimized to reduce damage to the sleeve 50 during installation. In the case of the rotor assembly 240 and mandrel 246, the projection 265 on the mandrel 246 is placed into the alignment opening 245 on the rotor assembly 240.

The mandrel 46 can be attached to the rotor assembly 40 with the fastener 54 engaging the bearing datum 58 on the rotor assembly 40. While the illustrated example in FIGS. 1, 2, and 5 show two jack screws 60, four or more jack screws 60 can be arranged circumferentially around the bearing datum 58 and can be used to remove the mandrel 46 from the rotor assembly 40 after the sleeve has been installed.

In a further example, the alignment of the mandrel 46 with the rotor assembly 40 includes over molding the mandrel 46 and the rotor assembly 40 with the coating of material 70. The coating of material 70 can be machined to create a consistent transition for the sleeve 50 in a radial direction between the mandrel 46 and the rotor assembly 40.

At Block 306, the sleeve 50 is placed around a proximal end of the mandrel 46. Because the mandrel 46 includes a first cylindrical portion 48A having a diameter that is less than or equal to the inner diameter of the sleeve 50, the sleeve 50 is able to be placed over the mandrel 46 with relative ease and the ring 52 can be placed on the sleeve 50.

At Block 308, the sleeve 50 is pressed over the mandrel 46 and onto the rotor assembly 40 with the sleeve driver 28 on the press arm 26. The sleeve driver 28 engages the ring 52 to provide even pressure against the sleeve 50 while pressing to reduce the possibility of the sleeve 50 becoming damaged during installation. Because the mandrel 46 includes a cylindrical portion and a conical portion, the sleeve 50 expands in a radial dimension as it moves over the transitional portion to follow the outer diameter of the conical portion. As the sleeve 50 is pressed over the mandrel 46, pressurized air can build up within the interior chamber 31. The pressure can be released through the pressure relief hole 30 in the sleeve driver 28.

When the sleeve 50 is being pressed over the mandrel 46 and the rotor assembly 40, lubrication can be applied to at least one of the outer mandrel diameter 48 or the outer rotor diameter 56. As shown in FIG. 1, spray nozzles 80 can be used to apply the lubricant 82 to the outer diameters 48, 56. While two spray nozzles 80 are shown in the illustrated example, additional spray nozzles 80 could be positioned circumferentially around the mandrel 46 and rotor assembly 40 to provide additional lubrication while pressing. In another example, the at least one of the rotor assembly 40 and the mandrel 46 include internal passageways 84 (FIG. 1) for distributing lubricant along the outer diameters 48, 56.

Furthermore, the sleeve 50 is pressed over the mandrel 46 and the rotor assembly 40 at a speed sufficient to reach a hydrodynamic lubrication velocity in the lubricant 82. In one example, the speed is greater than 0.5 to 1 meter per second for 30 MPa sleeve pressure.

At Block 310, the sleeve driver 28 is retracted from the mandrel 46 and the ring 52 is removed from being located around the rotor assembly 40 and the mandrel 46. The mandrel 46 can then be separated from the rotor assembly 40 at Block 312 leaving the sleeve 50 surrounding the outer rotor diameter 56 and applying a compressive force to the rotor assembly 40.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characterization) described in connection with the aspect is included in at least one aspect described herein, and may or may not be present in other aspects. In addition, it is to be understood that the described elements may be combined in a suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, test standards are the most recent standard in effect as of the filing date of this application, or, if priority is claimed, the filing date of the earliest priority application in which the test standard appears.

Unless defined otherwise, technical, and scientific terms used herein have the same meaning as is commonly understood by one of skill in the art to which this disclosure belongs.

While the above disclosure has been described with reference to exemplary embodiments, it will be understood by those skilled in the art that various changes may be made, and equivalents may be substituted for elements thereof without departing from its scope. In addition, many modifications may be made to adapt a particular situation or material to the teachings of the disclosure without departing from the scope thereof. Therefore, it is intended that the present disclosure is not limited to the particular embodiments disclosed but will include embodiments falling within the scope thereof.

What is claimed is:

1. An assembly comprising:
a rotor assembly including a rotor stack having an outer rotor diameter and a rotor shaft extending along a rotational axis of the rotor assembly;
a mandrel having an outer mandrel diameter extending between a proximal end and a distal end with a rotor engaging surface at the distal end of mandrel, wherein the outer mandrel diameter includes a first cylindrical portion adjacent the proximal end, a conical portion distal of the first cylindrical portion with a first transitional portion connecting the first cylindrical portion to the conical portion; and
a sleeve having an inner sleeve diameter that is less than the outer rotor diameter when in an unexpanded state.

2. The assembly of claim 1, wherein an inner diameter of the mandrel engaging an outer diameter of a bearing datum on the rotor assembly and a fastener engages the bearing datum for securing the mandrel to the rotor assembly.

3. The assembly of claim 2, wherein the mandrel includes a second cylindrical portion distal of the conical portion with the second cylindrical portion connected to the conical portion with a second transitional portion.

4. The assembly of claim 3, wherein at least one of the first transitional portion or the second transitional portion on the mandrel includes a radius of curvature.

5. The assembly of claim 4, wherein the radius of curvature is greater than a thickness of the sleeve divided by two times a maximum material strain of a material of the sleeve.

6. The assembly of claim 1, including a polymeric ring having a driver contact surface on a first axial face and a sleeve contact surface on a second axial face configured to engage a proximal end of the sleeve.

7. The assembly of claim 6, including a press having a sleeve driver with a body portion defining a central opening for surrounding the mandrel and a distal end having a ring engagement surface for engaging the driver contact surface on the polymeric ring and a pressure relieve hole extending through and defined by the body portion.

8. The assembly of claim 1, including a fixture base having a cylindrical body defining a central opening for accepting a portion of the rotor shaft of the rotor assembly.

9. The assembly of claim 1, including a flange located on an outer perimeter of the distal end of the mandrel, wherein a radially inner side of the flange defines a portion of a circumferential channel recessed into the distal end of the mandrel.

10. The assembly of claim 1, wherein the outer rotor diameter and the outer mandrel diameter are each covered in a continuous coating of material and the continuous coating of material includes a radially outer surface located radially outward from the outer rotor diameter and the outer mandrel diameter relative to the rotational axis.

11. The assembly of claim 1, wherein the distal end of the mandrel includes at least one projection configured to be accepting within a corresponding alignment opening defined by a portion of the rotor assembly.

12. A method of installing a sleeve on a rotor assembly, the method comprising:
aligning an outer mandrel diameter of a mandrel relative to an outer rotor diameter of a rotor assembly, wherein the outer mandrel diameter includes a first cylindrical portion adjacent a proximal end, a conical portion distal of the first cylindrical portion, and a first transitional portion connecting the first cylindrical portion to the conical portion; and
pressing the sleeve over the outer mandrel diameter and onto the rotor assembly with a driver on a press, wherein the sleeve is configured to apply a compressive force to a portion of the rotor assembly surrounded by the sleeve.

13. The method of claim 12, including positioning a polymeric ring between a proximal end of the sleeve and a distal end of the driver.

14. The method of claim 12, wherein pressing the sleeve over the outer mandrel diameter includes expanding a radial dimension of the sleeve to align with a radial dimension of an outer surface of the rotor assembly.

15. The method of claim 12, including attaching the mandrel to a bearing datum on a shaft of the rotor assembly to align an outer rotor diameter on a rotor stack with the outer mandrel diameter, wherein an inner diameter of the mandrel engages an outer diameter of a bearing datum on the rotor assembly.

16. The method of claim 15, wherein the mandrel includes a second cylindrical portion distal of the conical portion and connected to the conical portion by a second transitional portion.

17. The method of claim 12, wherein a distal end of the mandrel includes a flexible flange surrounding an outer perimeter of the distal end that deflects to align with a radially outer surface of the rotor assembly.

18. The method of claim 12, including over molding the mandrel and the rotor assembly with a polymer layer of material and machining the polymer layer of material across the mandrel and the rotor assembly to create a consistent transition for the sleeve in a radial direction between the mandrel and the rotor assembly.

19. The method of claim 12, including applying a lubricant to the outer mandrel diameter and the outer rotor diameter and pressing the sleeve over the mandrel and rotor assembly with a velocity that is equal to or greater than a hydrodynamic lubrication velocity of the lubricant applied.

20. A press assembly for assembling a sleeve on to a rotor assembly comprising:
a press having a driver;
a fixture for supporting the rotor assembly, the rotor assembly including rotor stack having an outer rotor diameter and a rotor shaft extending along a rotational axis of the rotor assembly;
a mandrel having an outer mandrel diameter extending between a proximal end and a distal end with a rotor engaging surface at the distal end of the mandrel, wherein the outer mandrel diameter includes a first cylindrical portion adjacent the proximal end, a conical portion distal of the first cylindrical portion and a first transitional portion connecting the first cylindrical portion to the conical portion; and
the sleeve includes an inner sleeve diameter that is less than the outer rotor diameter when in an unexpanded state.
